(19) United States
(12) Patent Application Publication
(10) Pub. No.: US 2009/0278343 A1
(43) Pub. Date: Nov. 12, 2009

(54) Coplanar-joined printing carrier made from at least two partial printing carriers, the partial printing carriers, and the method for their fabrication

(75) Inventor: Jules Fischer, Oberwil-Lieli (CH)

Correspondence Address: D. PETER HOCHBERG CO. L.P.A., 1940 EAST 6TH STREET, CLEVELAND, OH, 44114, US

(73) Assignee: Fofitec AG - a Swiss Corporation, Dottikon (CH)

(21) Appl. No.: 12/288,528

(22) Filed: Oct. 21, 2008

(30) Foreign Application Priority Data
May 9, 2008 (CH) 00785/08
Jun. 3, 2008 (CH) 00839/08

(51) Int. Cl. B42D 5/00; B41J 15/00; B65H 37/04

(52) U.S. Cl. 281/17; 428/40.1; 412/8; 270/58.07; 270/58.08

(57) ABSTRACT

In a coplanar-joined printing carrier of at least two sheet-like partial printing carriers, wherein one of the partial printing carriers has a paper layer, the invention provides that the paper layer of the one partial printing carrier is weakened in its thickness along a marginal strip by removal of a partial layer, the other partial printing carrier has less thickness along one marginal strip than elsewhere, and the two partial printing carriers are joined together along their two marginal strips. Also described are a method especially suited to the making of such a printing carrier.

This application claims foreign priority based on Swiss Patent Application Serial No. 00785/08 filed May 9, 2008, and Swiss Patent Application Serial No. filed Jun. 3, 2008, the content of both of which is incorporated herein by reference in its entirety.

### BACKGROUND OF THE INVENTION

1. Field of the Invention

The present invention concerns a coplanar-joined printing carrier made from at least two sheet-like partial printing carriers, wherein one of the partial printing carriers has a paper layer. The invention also concerns a partial printing carrier with a paper layer, as well as a method for making such a printing carrier and partial printing carrier.

By printing carrier or partial printing carrier in the context of the present invention is meant a substrate, especially a sheet, web, or page-like substrate, which is or can be printed on one or both sides. The substrate can have a single or multiple-layer construction.

2. Description of the Prior Art

To an increasing extent, printing carriers based on paper sheets are required, which are refined by local affixed items, usually in conjunction with punching, and which contain integrated cards or labels, for example. The affixed items generally involve laminates, which contain the plasticization and adhesive layers required for the integrated cards or labels. As an example, one can refer to WO 95/20493.

The affixed items cause local thickening of the printed carriers, which is not a concern for the individual sheets of printing carriers, but when placed in a stack they add up and result in an increasingly skewed stack as it increases in height.

To avoid this skewing, which prevents a full loading of the magazine of sheet printers, various solutions have already been proposed.

One proposal per DE 197 41 563 involved making a single printed carrier with integrated card, instead of local affixing, i.e., providing it with the layers needed for the integrated card over the full surface. However, this solution could not win out, due to the much larger quantity of costly material needed for this. Also, the printing carriers in this embodiment are quite rigid and heavy and are hard to fold, due to the foil layers which are usually present.

A proposal per WO 2005/100006 was to keep the affixing on part of the surface and prevent a skewed position for the sheets in a stack by deformations embossed in the paper material, also increasing its thickness. However, due to the high elasticity of paper, these deformations have not proven to be sufficiently stable over time.

In WO 92/05036, a printing carrier was proposed in the form of a card laminate with a first card, i.e., made of paper, and a second card, while the second card is secured in a segment of the first card carved out by pressure action and has a surface which is coplanar with it, so that no skewing can occur in the stack. However, it is assumed that this proposal could not be realized successfully, because the cavity in the paper material of the first card should break down over time, due to the high elasticity of paper, as was the case with the aforementioned deformations.

In WO 00/41895, a coplanar-joined printing carrier made from at least two sheet-like partial printing carriers was proposed, the partial printing carriers being glued together at their abutting edges with basically no overlapping. However, it was not possible to achieve a sufficient strength of connection for practical purposes, or at least not with reasonable expense.

### SUMMARY OF THE INVENTION

The invention sets itself the problem of specifying a printing carrier of the kind mentioned at the outset, in which the two partial printing carriers are robustly joined together in coplanar manner by a technically simple and rationally implemented method and wherein the partial printing carrier comprising the paper layer can simply consist of this paper layer and the other partial printing carrier can consist, in particular, of a laminate suitable for integrated cards.

This problem is solved according to the invention by a printing carrier with the features of patent claim 1. The invented printing carrier is accordingly characterized in that the paper layer of the one partial printing carrier is weakened in its thickness along one marginal strip by removal of a partial layer, the other partial printing carrier has less thickness along one marginal strip than elsewhere, and the two partial printing carriers are joined together along their two marginal strips.

The two partial printing carriers can be joined together in stable manner, especially in mutual overlapping, by their two marginal strips. In the overlap region, one can achieve an overall thickness in this way that is not greater than the thickness of the partial printing carriers elsewhere. As an alternative, the two partial printing carriers could also be joined together by their marginal strips in abutment, with at least one strip, especially a glue strip, and the thickness of the strip will be offset by the lesser thickness of the partial printing carriers in the region of their marginal strips, and likewise the at least one strip will not cause any cumulative increase in thickness as compared to the thickness of the individual partial printing carriers themselves.

According to a first preferred embodiment of the invention, the partial layer is removed from the paper layer by tearing off. In this regard, the invention utilizes the knowledge that paper material can be easily split and that a strip with a partial layer of the paper material after making a suitable starting tear can be further torn off almost endlessly with extremely constant thickness.

Alternatively or in addition, the partial layer could be removed by an abrasion process, especially by grinding or milling.

If the second printing carrier is a multilayered card laminate with at least two layers which can be separated from each other, a strip can be removed from at least one layer of this laminate, thereby also achieving a reduced thickness along a marginal strip.

Preferably, the marginal strip of the paper layer of the one partial printing carrier is delimited from the rest of the paper layer by an incision in the paper layer.

The same holds for the other partial printing carrier, especially when this is a laminate with at least two layers which can be peeled away from each other.

The invention also involves a partial printing carrier with a paper layer for making a printing carrier according to the invention, in which the paper layer is weakened in its thickness along one marginal strip by removal of a partial layer partial layer. Preferably, the partial layer of the paper layer is removed by tearing off. Alternatively or in addition, the partial layer could be removed by an abrasion process, especially by grinding or milling.

The partial printing carrier can be provided with an adhesive layer covered by a peel-off cover layer at the marginal strip of the paper layer.

Moreover, the invention deals with a method for making a printing carrier or a partial printing carrier according to the invention, wherein the partial layer is removed from the paper layer by tearing off along the marginal strip.

Preferably, the partial layer of the paper layer is torn off with an adhesive strip. Critical to the resulting thickness of the partial layer are the conditions of the tearing off. Preferably, the adhesive strip is pulled off together with the partial layer of the paper layer adhering to it via a roller. In endless production, when the paper web and the adhesive strip are in the form of endless webs, the two webs are led across two rollers running against each other. Thanks to the very uniform conditions of tearing off, which is more like a lifting off in this case, one can achieve a very uniform thickness for the partial layer and, thus, also for the remaining layer of the paper layer along the marginal strip. In particular, the thickness of the partial layer can be influenced by the choice of diameter of the roller(s).

The invention also deals with a method for making a printing carrier or a partial printing carrier according to the invention, wherein the partial layer of the paper layer is removed along the marginal strip by abrasion, especially by grinding and/or milling.

In order for the marginal strip of the paper layer to have a smooth edge against the remaining paper layer, before removing the partial layer it is delimited by an incision in the paper layer. The depth of the incision should correspond roughly to the desired thickness of the partial layer.

If the second printing carrier is a multilayered laminate, the marginal strip on it can likewise be delimited from the rest of the laminate prior to the peeling off of the at least one layer by an incision in the laminate. The depth of the incision should correspond at least to the desired thickness of the partial layer.

A glue layer is preferably used for the joining of the two partial printing carriers along their two marginal strips with the two marginal strips overlapping each other, and also preferably a glue layer will be transferred dry from one carrier to one of the two marginal strips. This has the advantage over a wet applying of the glue layer that the glue layer is then available immediately for the gluing of the two partial printing carriers and does not first have to be dried. A hot glue could also be considered, or a connection using an already existing coating by pressing the two webs together.

Finally, the method of the invention is preferably an endless method, in which the two partial printing carriers are present as webs and are processed preferably at the same time, for example, by running off a roller. Besides their being joined together, the two partial printing carriers could also undergo further processing steps in the same run through the machine, such as being printed upon or cut by punch, and then finally be detached from each other.

### BRIEF DESCRIPTION OF THE DRAWINGS

The invention shall now be explained more closely by means of sample embodiments in connection with the drawing. This shows, schematically:

FIG. 1g) a coplanar-joined printing carrier according to the invention, made from two partial printing carriers, and a)-f) the individual steps for making this printing carrier;

FIG. 2a ) a device for making the printing carrier of FIG. 1 in an endless process, wherein two webs corresponding to the partial printing carriers are processed and joined together in coplanar manner, b) and b′) aspect views, and c) and c′) cross sections of these webs; d) shows a modified punching unit of the device illustrated in a);

FIG. 3a), a′), b), b)′ and c) cross sections of the webs on various cylinders of the device of FIG. 2a );

FIG. 4a)-c) alternative embodiments for the coplanar connection of two partial printing carriers by means of strips;

FIG. 5a ) a printing carrier per the invention in cross section with integrated card, and b) the printing carrier with card removed;

FIG. 6a ) a printing carrier per the invention in cross section with adhesive label, and b) the printing carrier with adhesive label removed;

FIG. 7 in a representation per FIG. 6b), a printing carrier per the invention in cross section with folding card removed; and

FIG. 8a ) another printing carrier per the invention in cross section with integrated flip card, b) steps for making the flip card, and c) the flip card released.

In the figures, the size relations of the various parts are not realistic. In particular, the thicknesses of the individual layers are greatly exaggerated for better visibility.

### DETAILED DESCRIPTION OF THE PREFERRED EMBODIMENTS

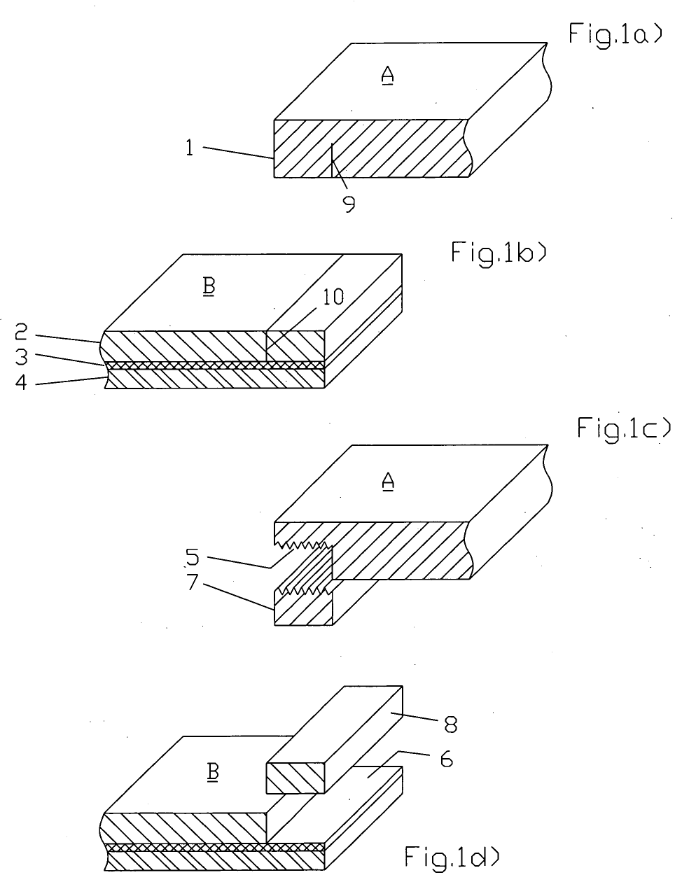

FIG. 1g) shows a printing carrier A/B of two sheet-like partial printing carriers A and B, joined coplanar with mutual overlapping. Partial printing carrier A consists of a single ply or layer 1 of paper. Partial printing carrier B is a laminate of roughly corresponding thickness of three layers 2, 3 and 4, where layers 2 and 4 can likewise be a paper layer or a foil layer and layer 3 is a so-called peel glue layer, which allows the layer 2 to be peeled off from it while remaining behind on layer 4.

For purpose of their coplanar joining, the partial printing carriers A and B are each weakened in thickness along a marginal strip 5 and 6 by removal of a strip-like partial layer 7 from partial printing carrier A and a strip-like layer 8 from partial printing carrier B. To facilitate this and to obtain a clean boundary for the marginal strips 5 and 6, the partial printing carriers A and B can be provided with incisions 9 and 10 beforehand. FIGS. 1a) and b) shows the two partial printing carriers A and B in the original state, but already provided with such incisions 9 and 10. FIG. 1c) shows the strip-like partial layer 7 of paper layer 1 along the incision 9 of paper layer 1 and thus separated from partial printing carrier A, the separation having been achieved by tearing off with shredding of the paper material. FIG. 1d) shows the strip-like layer 8 along the incision 10 separated from partial printing carrier B, forming part of layer 2 and having been detached from the peel glue layer 3. After this, on at least one of the weakened marginal strips 5 or 6, here, marginal strip 6 of partial printing carrier B, an adhesive 11 is applied in a strip, as shown by FIG. 1e). As shown in FIG. 1f), the two partial printing carriers A and B are finally glued together by their marginal strips 5 and 6 in mutual overlapping, so that they come to lie essentially coplanar, as shown by FIG. 1g). With suitable weakening of the two partial printing carriers A and B, possibly allowing for the thickness of the glue 11, one obtains at most the same thickness in their overlap region 5/6 as the two partial printing carriers themselves have, as is preferable. Then the printing carrier A/B assembled from the two partial printing carriers A and B likewise has an essentially corresponding thickness over its entire surface.

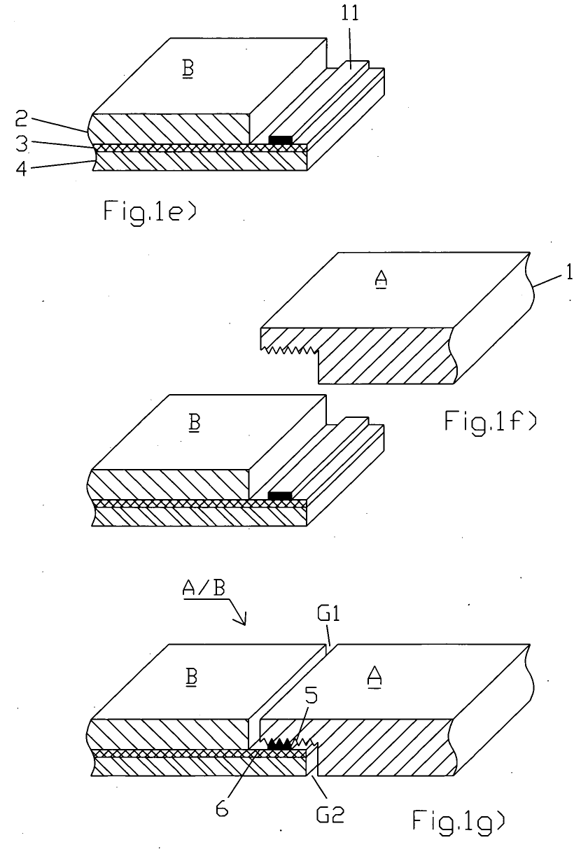

FIG. 2a) shows a device for making a printing carrier A/B per FIG. 1 in an endless process using partial printing carriers A and B, which are present as endless webs and are unrolled from feed rollers 20 and 21. FIG. 2b) shows views of the webs A and B moving through the device of FIG. 2a). FIG. 2c) shows a section through the finished printing carrier A/B.

From the feed roller 20, web A is taken to a first punch unit I with a punch cylinder 22 at the bottom and a counter cylinder 23 on top, where it runs against the counter cylinder 23 in the punch unit. The punch cylinder 22 is provided with at least one encircling blade to apply the incision 9 of FIG. 1 as the web A runs through the gap between the two cylinders 22 and 23. Ahead of this gap in the direction of rotation, a roller 24 lies against the punch cylinder 22, by which a first adhesive strip K1 with a supporting foil layer and a glue layer, pulled off from a roller 25, is transferred onto the punch cylinder 22 with the glue layer pointing outward. At the same time, a cover for the glue layer, such as one in the form of a silicone paper S1, is peeled off from the glue strip K1 on the roller 24 and fed to a roller 26, on which it is wound. The glue strip K1 comes into contact with the web A in the gap between the two cylinders 22 and 23 and is glued firmly to it under pressure there. Next—taking along with it a partial layer of the paper layer of web A, as shall be further explained below—it continues to run about the punch cylinder 22 until it reaches a deflection roller 27, by which it is taken away from the punch cylinder and feed to a wind-up roller at 28.

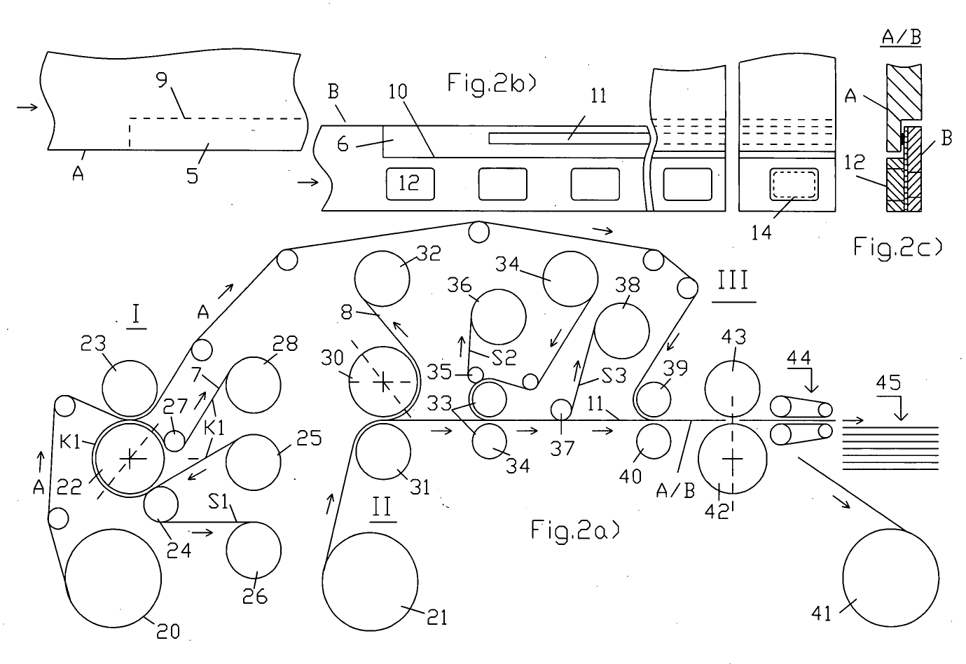

The glue strip K1 is so dimensioned in terms of width and so oriented relative to the web A and the blade 22.1 producing the incision 9 in it (FIG. 3a)) that it comes to lie between one of the side margins of web A and the incision 9 and preferably also the spacing region between them is basically filled up. In particular, it lies close against the blade 22.1 on the punch cylinder 22.

Now, since the adhesive force of the glue layer of the glue strip K1 to the paper material of web A is chosen to be greater than the internal strength of the paper material, it tears or shreds this in the direction of travel in the aforesaid marginal strips 5, so that a partial layer of the paper layer corresponding to the partial layer 7 of FIG. 1 remains sticking to the glue strip K1 on the punch cylinder 22, while web A otherwise continues to run about the counter cylinder 23. The partial layer 7 torn off by the glue strip K1 and sticking to it is wound up along with the glue strip K1 on the roller 28. The specific tearing conditions can be maintained precisely constant in the described procedure, so that an approximately constant tearing depth with correspondingly constant weakening of web A along its marginal strip 5 results.

Accordingly, three processes take place nearly at the same time in the gap between the two cylinders 22 and 23: making of the incision 9 for a straight boundary of the marginal strip 5 being weakened, applying of the glue strip K1, and tearing off of the partial layer 7 with the glue strip K1.

Web A with its weakened marginal strip 5 is then taken around various deflection rollers, including a second punch unit II, as is described below.

The second punch unit II has a punch cylinder 30 on top and a counter cylinder 31 on the bottom. This second punch unit II is fed the web B from the feed roller 21 such that it runs against the counter cylinder 31. The punch cylinder 30, like the punch cylinder 22, is provided with at least one encircling blade (30.1 in FIG. 3b)) to make the incision 10 of FIG. 1 as web B runs through the gap between the cylinders 30 and 31. Thanks to the incision 10, the strip-like layer 8 of FIG. 1d) is cut free and can then be pulled around the punch cylinder 30 off from the rest of web B and be wound up on a roller 32.

Web B with its thus weakened marginal strip 6 is then taken to a station in which an adhesive corresponding to the adhesive 11 of FIG. 1e) is applied in a strip to the weakened marginal strip 6. The adhesive 11 is applied dry by a pair of rollers 33, using pressure, and for this it is fed from a feed roller 34, on which it is arranged between two cover layers of silicone paper S2 and S3. One of these cover layers, S2, prior to the applying of the glue layer 11, is pulled off from this by a roller 35 running against the roller 33 and wound up on a roller 36. The other cover layer, S3, is only pulled off by a roller 37 after the applying of the adhesive 11 to web B and wound up on a roller 38. The adhesive 11 then lies exposed on the top side of web B at its marginal strips 6. In order for the adhesive 11 to be separated from the cover layers S2, S3 in the proper sequence, its adhesive force must be slightly less for the cover layer S2 than for the cover layer S3.

At another station with two pressing rollers 39 and 40, web A and web B are brought together and glued to each other with overlapping of their two weakened marginal strips 5 and 6 by the adhesive 11, under pressure, as is also evident from FIG. 2c). It is important that the pressure be exerted by the rollers 39, 40 in the overlap zone, for which purpose a so-called make-ready is provided there. It can be seen from FIG. 2a) how web A is taken around the pressing roller 39 and joined to web B. In FIG. 2b) one can see that the two webs A and B have been moved laterally relative to each other by the device so that their two weakened marginal strips arrive in the station with the pressing rollers 39 and 40 precisely in the desired overlap with each other and are pressed together.

This already provides a printing carrier A/B according to the present invention, albeit one in the form of an endless web, which is wound up on a roller 41 and could be made available for further endless processing at a print shop, for example. But in practice there is an increasing need for single sheets which can be handled by sheet printers. Therefore, there is also provided in the device of FIG. 2a) a third punch unit III with a punch cylinder 42 and a counter cylinder 43, and on the punch cylinder 42 there is at least one blade directed transversely to the direction of travel of the web A/B for cutting single sheets to length from the web A/B. 44 denotes a device for picking up and stacking the single sheets and 45 a stack of sheets. The sheets can have typical formats such as A4 or letter.

FIGS. 3a), b) and c) illustrate the relations at the three punch cylinders 22, 30 and 42 in the punch units I, II and III, the individual figures each showing a longitudinal section through the punch cylinder and the cross sectional planes being indicated by broken lines, as in FIG. 2a).

FIG. 3a) shows the relations at punch cylinder 22 of the first punch unit I. The plane of the cross section is chosen here to be slightly slanted, so that it cuts the upper edge of the punch cylinder 22 shortly after the gap between it and the counter cylinder 23, represented only in FIG. 2a). The blade encircling the punch cylinder 22 to produce the incision 9 in web A is denoted by 22.1 and is shaped on a thin punching sheet steel, which is held magnetically on the punch cylinder 22. For this, the punch cylinder 22, like the other punch cylinders incidentally, is fashioned as a magnetic cylinder. The adhesive tape K1, as already described, is fed to the punch cylinder 22 so that it lies tightly against the blade 22.1. In the gap between the punch cylinder 22 and the counter cylinder 23, the blade 22.1 penetrates into web A. Also here the adhesive strip K1 is glued together with web A under high pressure. Practically at the same time, the tearing off and the separation of the partial layer 7 from web A begins in the gap, since the adhesive strip K1 with the partial layer 7 adhering to it continues to run through a certain angle of rotation on the punch cylinder 22, while web A runs about the counter cylinder 23 and after the gap it is removed from the adhesive strip K1 and the partial layer 7, as can be seen in FIG. 3a).

FIG. 3b) shows the relations on the punch cylinder 30 of the second punch unit II. Here again, the plane of the cross section is chosen to be slightly slanted, so that it cuts the lower edge of the punch cylinder 30 shortly after the gap between it and the counter cylinder 31, represented only in FIG. 2a). The blade encircling the punch cylinder 30 to produce the incision 10 in web B is denoted by 30.1 and again is shaped on a thin punching sheet steel, which is held magnetically on the punch cylinder 30. The strip-like partial layer 8 of web B, cut free by the incision 10, is pulled off from web B, since it continues to run on the punch cylinder 30 for a certain angle of rotation, while web B leaves the gap between the punch cylinder 30 and the counter cylinder in a straight line.

In the sample embodiments just described, the marginal strips 5 and 6 of the two partial printing carriers A and B are each oriented straight and parallel with each other, both as regards their outer edges and the incisions 9 and 10. As a result, on the finished printing carrier A/B there are produced two hinge zones, denoted as G1 and G2 in FIG. 1g), along which the two partial printing carriers A and B can be turned relative to each other with slight resistance. For many applications, this can be immaterial, or even advantageous, but for others it can be undesirable. In the latter case, the hinge effect can be largely avoided and a deflection-resistant connection can be produced by a mutual toothing of the two partial printing carriers along their marginal strips 5 and 6. For this, it is enough to make the two marginal strips 5 and 6 undulating in opposite directions, both in terms of their outer edges and in terms of the incisions 9 and 10, as is represented in FIG. 2b′), the incisions being denoted here as 9′ and 10′. For this, the blades on the punch cylinders 22 and 30 must have a corresponding undulating shape, as is shown by FIGS. 3a′) and 3b′), the corresponding blades being denoted as 22.1′, 22,2′, 30.1′ and 30.2′. The blades 22.2′ and 30.2′ are needed here in addition, in order to cut the outer edges of webs A and B in wavy pattern, resulting in cutting scraps. The two blades 22.1 ′ and 22.2′ on the punch cylinder 22 can also be used advantageously to cut out, from the adhesive strip K1 fed from the roller 25 with straight edges, an adhesive strip K1′ exactly matching the wavy contour; here again, cutting scraps will result, but they can be taken away together with the cover S1.

The thickness of the partial layer 7 tom away from the paper layer of the partial printing carrier A for the weakening of its margin side, and thus the mass of this weakening, depends on the paper grade used and in part on the speed of tearing, but also in particular on the angle of tearing, as the thickness decreases as the angle of tearing becomes larger. The depth of the incision 9 plays practically no role in this context. A sharp-edge separation of the partial layer 7 will result even if the depth of the incision 9 is somewhat less than the thickness of the partial layer 7. Neither does the force of adhesion to the paper surface of the glue strip K1 used in the device of FIG. 2a) play any major role for the thickness of the partial layer 7, as long as this force of adhesion is just large enough.

In the device of FIG. 2a), the angle of tearing is determined, on the one hand, by the diameter of the punch cylinder 22, and on the other hand by that of the counter cylinder 23. Typically, these diameters amount to 110-150 mm for the punch cylinder 22 and 60-140 mm for the counter cylinder 23 and thus are relatively large, which gives a relatively small angle of tearing and a large thickness of partial layer 7 tom off, which is for the most part beneficial in practice. However, if one wishes to decrease this thickness, one can use, for example, the modified punch unit I′, as depicted in FIG. 2d). Here, the web A and the glue strip K1 with the attached partial layer 7 are separated from each other on a pair of rollers 29 with distinctly smaller diameter, arranged after the punch cylinder and counter cylinder.

Thanks to the above described measures, the thickness of the partial layer 7 can be adjusted relatively exactly to the particular desired value, especially in the range of 20-120 μm, for example, a thickness of 25 μm is suitable for paper with 80 g/m2 and a thickness of 50 μm for paper with 120 g/m2. For paper over 140 g/m2 and thickness over 185 μm, the thickness of the partial layer 7 can be up to 100 μm.

The laminate used in FIGS. 1-3 for the partial printing carrier B and the web B is specially suited for the making of integrated cards, especially when the layer 2 is sufficiently thick, rigid, and thus self-supporting. The device of FIG. 2a), thanks to the punch units which are present anyway, allows one to also create just such integrated cards at least in the laminate of web B in the layer 2 in the same production run with the joining of the two webs A and B. It is sufficient in theory to provide the punching sheet steel held on the punch cylinder 30 with an additional encircling blade, as depicted in FIG. 3b) and FIG. 3b′) and denoted as 30.3, and to use this to cut into web B on the side with the layer 2 down to the depth of the peel glue layer 3. The cards cut out in this way along their periphery from the layer 2 are denoted by 12 in FIG. 2b) and FIG. 2b′) and the corresponding incision in layer 2 by 13 in FIG. 3b) and FIG. 3b′). The integrated cards 12 are held in web B and in the finished printing carrier A/B by the peel glue layer 3 on the layer 4, but can also be detached from the layer 4 by virtue of the separation properties of the peel glue layer 3 and taken out from the printing carrier A/B.

On the punch cylinder 42 of the third punch unit III of the device of FIG. 2a) one could also provide a punching sheet steel, as depicted in FIG. 3c), for example one with an encircling blade 42.1, and this blade 42.1 could be used to cut out individual sheets of printing carrier from the web A/B, producing a punching grid (rather than cutting the web to length and cutting it transversely). Alternatively or also additionally, one could use an encircling blade 42.2 to cut into layer 4 of web B. This would be of interest, e.g., within the contour of the integrated cards 12 produced in layer 2 of web B, as shown by broken line in FIG. 2b) or FIG. 2b′) and denoted by 14, because then a layer would be produced that goes along with the integrated cards 12 when taken out from the printing carrier, which could be provided with a previously applied imprinting, for example.

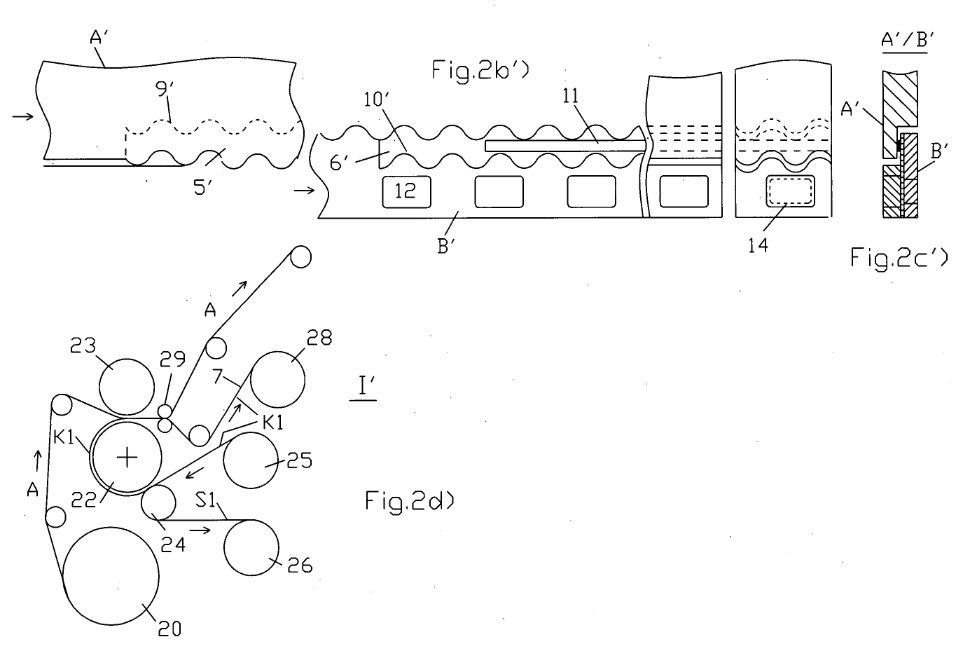

In the above-described sample embodiments, the partial printing carriers A and B were joined together coplanar with mutual overlapping of their two weakened marginal strips 5 and 6. FIG. 4a)-c) shows how this is essentially possible without any mutual overlapping of these marginal strips, by abutment using one strip 15 or two strips 15 and 16, each time the strip or strips spanning the abutment region. The overall thickness consisting of the residual thickness of the two marginal strips and the thickness of the strip or strips should again correspond roughly to the thickness of the two partial printing carriers A and B. In particular, the strips 15 and 16 can be glue strips.

The partial printing carriers A and B are not further specified in their construction in FIG. 4. In fact, both of the partial printing carriers could be a single paper layer. One or both partial printing carriers could also be a multilayered laminate, such as that shown for partial printing carrier B in FIG. 1 and used for the making of integrated cards in FIGS. 2 and 3.

The multilayered laminate, such as that shown for partial printing carrier B in FIG. 1 and used for the making of integrated cards in FIGS. 2 and 3, could be a plastic film, especially for layer 2, e.g., one made of polyester with a thickness in the range of 75-250 μm. The peel glue layer could have a thickness in the range of 3-10 μm and the layer 4 could be a carrier layer with a thickness of 23-36 μm. In this case, there would result a total thickness for the partial printing carrier B and, thus, preferably also for the paper material of the partial printing carrier A between 101-296 μm. The paper material would preferably be one having a large volume with low weight, i.e., a low density.

The two marginal strips 5, 6, especially for a joint with mutual overlapping, could have a width between 3-12 mm, but preferably between 4-8 mm.

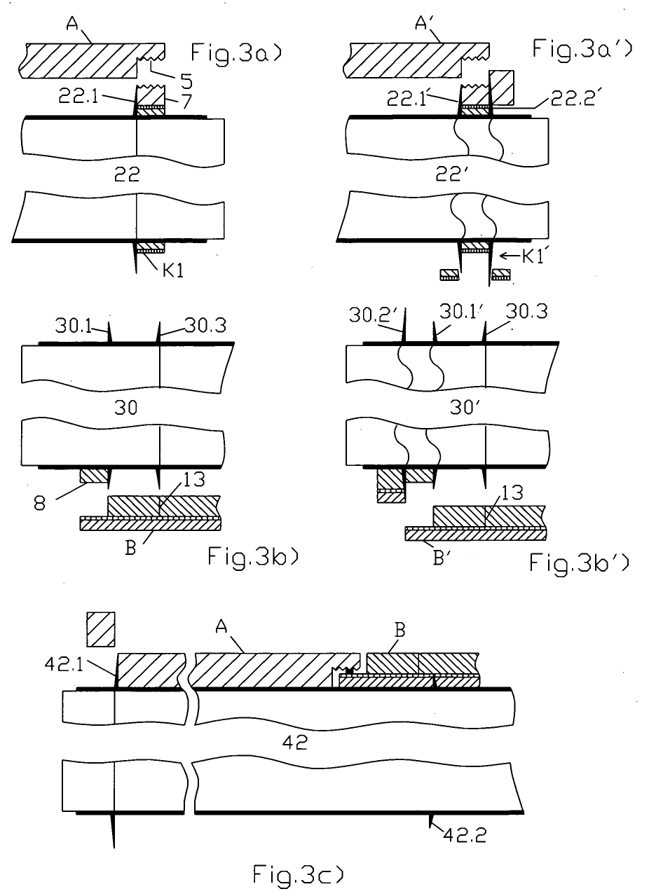

In FIGS. 5-8, further selected examples of the layer construction of the two partial printing carriers A and B are explained, on the one hand enabling their joining per the invention and on the other hand the making of various integrated products, while in FIGS. 5-7 the partial printing carrier A again consists only of a single paper layer and the partial printing carrier B is a multilayered laminate each time.

In FIG. 5, partial printing carrier B has the following layer construction from top to bottom: a first film cover layer 50, a first adhesive layer 51, a paper layer 52, a second adhesive layer 53, a second film cover layer 54, a peel glue layer 55 and a carrier layer of paper or film 56. Along one marginal strip, a strip with the layers 50-54 is removed from the peel glue layer 55 and is glued together there with a weakened marginal strip of the partial printing carrier A by an adhesive 57, with overlapping. Thanks to a punching 58 all around, reaching from the first film cover layer 50 down to the glue peel layer 55, an integrated card 59 is cut free in the partial printing carrier B, which thanks to the separation properties of the peel glue layer 55 can be taken out and is shown taken out in FIG. 5b). The card 59, as is often the case with such cards today, has a paper core 52 with plasticization on both sides by the film cover layers 50 and 54.

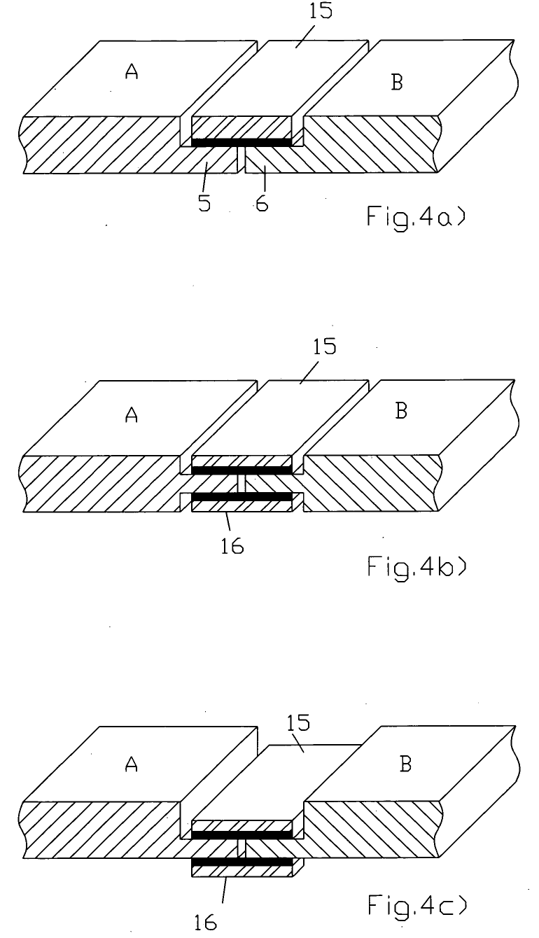

In FIG. 6, the partial printing carrier B has, from top to bottom, a layer 60 consisting of paper, for example, an adhesive layer 61, a silicone separation layer 62 and a carrier layer 63 of paper or film. Along one marginal strip, a strip with the layers 62 and 63 is removed from the adhesive layer 61 and glued together there with a weakened marginal strip of the partial printing carrier A by overlapping, using the adhesive of the adhesive layer 61. Thanks to a peripheral punching 64 in the layer 60, reaching down to the separation layer 62, an integrated self-adhesive label 65 is cut free in the partial printing carrier B, which can be taken out by virtue of the separation properties of the separation layer 62 and is shown taken out in FIG. 6b).

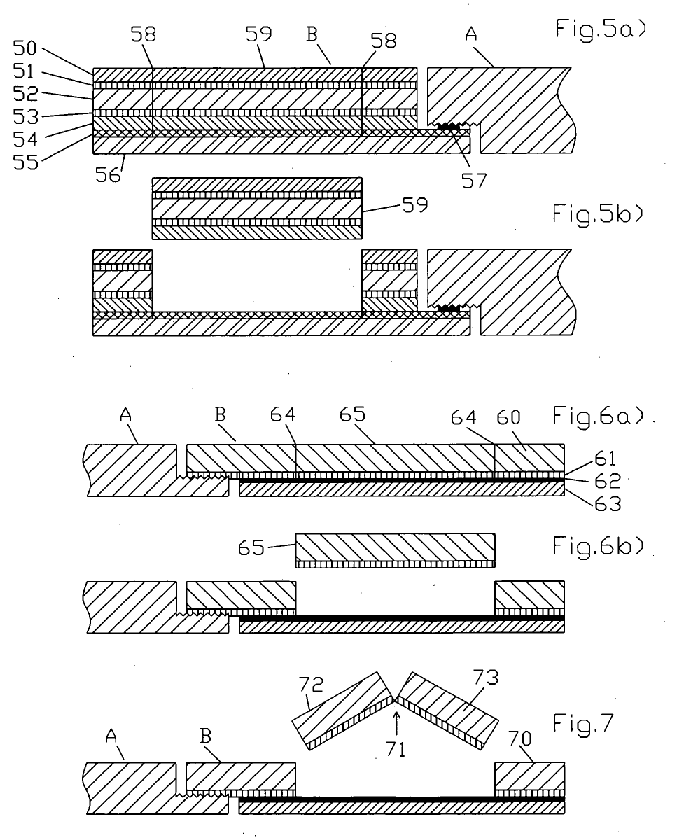

FIG. 7 shows how one could use a laminate with a wear layer 70, corresponding to the laminate of the partial printing carrier B of FIG. 6 in its construction, to also make, e.g., a folded card 71 which is not sticky on the outside, one which after being folded and having its parts 72 and 73 glued together has more than twice the thickness of the layer 70. The layer 70 here could advantageously be a relatively thick film layer.

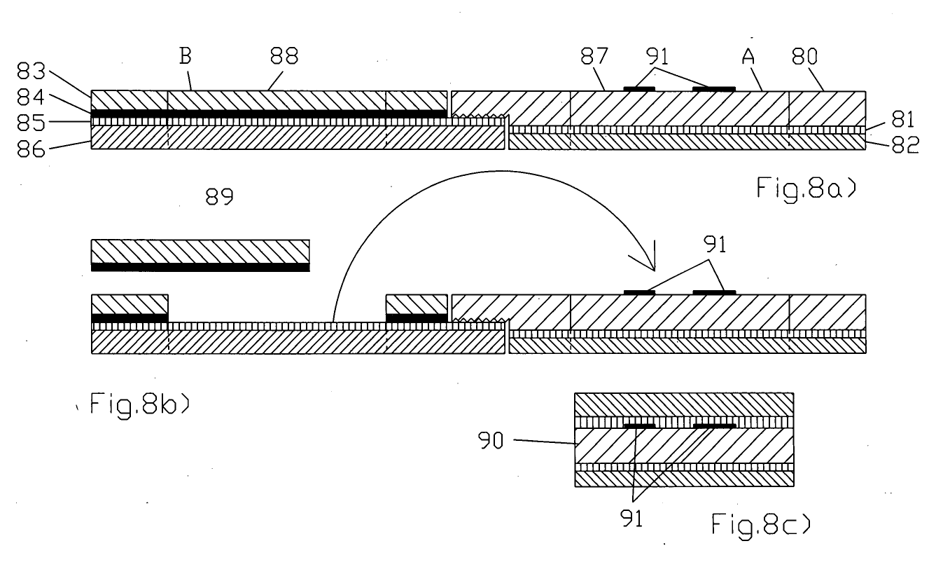

FIG. 8 shows an embodiment in which the partial printing carrier A is also a multilayered laminate and has, besides an upper paper layer 80, an adhesive layer 81 and a carrier layer 82 of tear-resistant film. This construction has the special advantage that no extra glue strip is needed for tearing off a partial layer of the paper layer 80 to weaken it at the marginal side, because such is already present thanks to the layers 81 and 82. It is enough to provide the partial printing carrier A with an incision and then the partial layer of the paper layer can be torn off at once with the integrated glue strip.

The partial printing carrier B of FIG. 8 has the opposite sequence of layers to that of FIG. 6 or 7 with the layers 83-86, where layer 86 is a transparent film layer. To weaken the margin of the partial printing carrier B, a strip with the layers 83 and 84 is removed, and layer 84 is a separation layer which can be easily detached from the adhesive layer 85. The adhesive of this adhesive layer is used directly to join the two partial printing carriers A and B, so that again no extra glue is needed for this.

From the construction described above, one can make, e.g., a flip card 90, in which an imprinting 91 previously applied to the paper layer 80 of the partial printing carrier A is arranged protected under a transparent film layer. For this, a first partial card 87 is cut free in the partial printing carrier A by a first punching, although it is still held in the partial printing carrier by individual bridges in the carrier layer 82. A second partial card 88 is cut free in the partial printing carrier B by a second punching, and likewise it is still held in the partial printing carrier B by individual bridges in the layer 86. To make the flip card, in a first step the part denoted as 89, comprising the layers 83 and 84, is removed from the partial printing carrier B, thus exposing the underlying region of the adhesive layer 85. In a second step, the partial printing carrier B is folded about the connection zone, as a hinge, onto the partial printing carrier A, whereupon the exposed adhesive layer 85 comes into contact with the surface of the partial card 87 provided with the aforesaid imprinting 91 and can be glued to it. In a third step, the finished flip card 90 can be removed from the printing carrier A/B by breaking the aforesaid bridges.

The above explained examples are in no way to be considered as conclusive. Instead, they merely illustrate that the present invention can be applied with a plurality of partial printing carriers of different construction and that even the most diverse of integrated products can be made with it in the context of the present invention.

To avoid a skewing when stacking, the two partial printing carriers joined together should have the same thickness whenever possible. However, certain thickness differences can be tolerable. The plane position resulting for a thickness difference up to at least ±5% will be sufficient for most applications.

Integrated cards, folded cards or labels typically have dimensions of 55 to 85 mm, so that the partial printing carrier B preferably used for their manufacture can have a width of 80 mm. For example, if the partial printing carrier B in a printing carrier A/B according to the invention is arranged in the format of an A4 sheet along one of its narrow sides, the partial printing carrier A will have a height of more than 200 mm, so that the partial printing carrier A, which can consist of an economical paper material, will make up the largest part of the surface of the printing carrier A/B.

In all sample embodiments described above, the recessing along the marginal strip of the partial printing carrier B, if this is a multilayered laminate, could be achieved by methods other than a weakening by removal of individual layers, in particular, directly during the making of the laminate.

With the method explained by means of FIG. 2, one can make printing carriers A/B with integrated card according to the invention in a single run through the production line, while the method and the device used for it may have to be somewhat modified depending on the layered construction of the partial printing carrier used. Thus, e.g., to make the printing carrier of FIG. 8, no extra glue strip K1 and also no glue 11 is required. Also, an adhesive could also be present already in web A and after the exposing of this adhesive only an uncoated tape would have to be applied. The tearing off of the partial layer of the paper layer can also be done entirely without the aid of a glue strip. It would also be possible to use the first punch unit of FIG. 2 solely with its accessory features and to create only a paper web weakened at its margin in a single run through, and this could even be delivered to another manufacturer as starting material for a later further processing. This weakened paper web could also already be provided along its weakened marginal strip with an adhesive layer covered by a detachable cover layer.

What is claimed:

1. A coplanar-joined printing carrier comprising:
at least two sheet-like partial printing carriers, wherein one of said at least two sheet-like partial printing carriers comprises a paper layer, a first marginal strip, and a removable partial layer, and a second of the at least two sheet-like partial printing carriers comprises a second marginal strip, wherein removal of said removable partial layer weakens the thickness of said one of the at least two sheet-like partial printing carriers along said first marginal strip;
said second of the at least two sheet-like partial printing carriers having a thickness along said second marginal strip being less than elsewhere on said second of the at least two sheet-like partial printing carriers; and
wherein said at least two partial printing carriers are operatively connected at said respective marginal strips.

2. The printing carrier according to claim 1, wherein the removable partial layer is removed by tearing off.

3. The printing carrier according to claim 1, wherein the removable partial layer is removed by abrasion, especially by grinding and/or milling.

4. The printing carrier according to claim 1, wherein said respective marginal strips overlap one another.

5. The printing carrier according to claim 1, further comprising at least one strip in abutment with said respective marginal strips.

6. The printing carrier according to claim 1, wherein said at least two partial printing carriers are substantially the same thickness.

7. The printing carrier according to claim 1, wherein a region where said respective marginal strips are operatively connected has a thickness, said thickness not being greater than the thickness of the thicker of the at least two partial printing carriers.

8. The printing carrier according to claim 1, wherein said first marginal strip of the paper layer is delimited from the rest of the paper layer by an incision in the paper layer.

9. The printing carrier according to claim 1, wherein said second of the at least two partial printing carriers is a laminate, said laminate having at least two layers able to be separated from each other, wherein one of said at least two layers being removable along the second marginal strip.

10. The printing carrier according to claim 9, wherein the second marginal strip of the laminate is delimited from the rest of the laminate by an incision in the laminate.

11. The printing carrier according to claim 1, wherein said respective marginal strips have a width between 3 mm to 12 mm.

12. The printing carrier according to claim 1, wherein at least one of said respective marginal strips has at least one edge and at least one side, wherein said at least one edge of said at least one of said respective marginal strips are straight or undulating on at least one side.

13. A partial printing carrier for making a printing carrier having a thickness, said partial printing carrier comprising a paper layer, a marginal strip, and a removable partial layer, wherein removal of said removable partial layer weakens the thickness of said partial printing carrier along said marginal strip.

14. The partial printing carrier according to claim 13, wherein the partial layer is removed by tearing off.

15. The partial printing carrier according to claim 13, wherein the partial layer is removed by abrasion, especially by grinding and/or milling.

16. The partial printing carrier according to claim 13, wherein the marginal strip of the paper layer is delimited from the rest of the paper layer by an incision in the paper layer.

17. The partial printing carrier according to claims 13, further comprising an adhesive layer covered by a detachable cover layer located on the marginal strip of the paper layer.

18. A method for making at least one partial printing carrier for a coplanar-joined printing carrier, said at least one partial printing carrier having a paper layer, a marginal strip and a removable partial layer, said method comprising removal of the partial layer along the marginal strip by tearing off for weakening the thickness of the paper layer.

19. The method according to claim 18, wherein partial layer is torn off with a glue strip.

20. The method according to claim 19, wherein the glue strip is pulled off by a roller.

21. The method according to claim 18, wherein the partial layer is removed by abrasion, especially by grinding and/or milling.

22. The method according to claim 18, wherein the marginal strip of the paper layer is delimited from the rest of the paper layer by an incision-in the paper layer.

23. A method for making a printing carrier, said printing carrier comprising two partial printing carriers each having a marginal strip, one of said partial printing carriers comprising a laminate having at least two layers which can be separated from each other, said laminate being used for the other of said partial printing carriers, said method comprises delimiting said marginal strip from the rest of the laminate by making an incision in the laminate and reducing the thickness of the laminate along the marginal strip by detaching at least one of the layers.

24. The method according to claim 23, wherein a glue layer is transferred from a glue carrier to one of the respective marginal strips for joining the two partial printing carriers along their respective marginal strips with the respective marginal strips overlapping each other.

25. The method according to claim 23, wherein said method is carried out as an endless process on running webs.

26. The printing carrier according to claim 11, wherein said respective marginal strips have a width between 4 mm to 8 mm.
